(19) United States
(12) Patent Application Publication
(10) Pub. No.: US 2026/0196720 A1
(43) Pub. Date: Jul. 9, 2026

(54) ROTATIONAL ANTENNA SYSTEM AND METHOD FOR DIRECTION FINDING AND/OR POSITION ESTIMATION

(71) Applicant: Rohde & Schwarz GmbH & Co. KG, Munich (DE)

(72) Inventors: Corbett ROWELL, Tuntenhausen (DE); Otmar WANIERKE, Munich (DE)

(21) Appl. No.: 19/406,332

(22) Filed: Dec. 2, 2025

(30) Foreign Application Priority Data
Jan. 8, 2025 (DE) 10 2025 100 401.3

(51) Int. Cl. H01Q 3/12; H01Q 13/10

(52) U.S. Cl. CPC H01Q 3/12; H01Q 13/10

(57) ABSTRACT

A rotational antenna system for direction finding and/or position estimation with respect to a signal source wirelessly providing a radio frequency (RF) signal is provided. Said rotational antenna system comprises at least two antennas, at least two receiving units respectively being in communication with a corresponding one of the at least two antennas, a rotary positioning unit configured to rotate at least one or at least two or each of the at least two antennas around a rotation point and/or a rotation axis, and a processing unit being in communication with the at least two receiving units. Each of the at least two receiving units is configured to obtain a corresponding one of at least two receive results with respect to the RF signal with the aid of the at least two antennas during rotation. The processing unit is configured to find a corresponding direction and/or to estimate a corresponding position with respect to the signal source based on at least one or at least two or each of the at least two receive results.

### RELATED APPLICATION

The application claims the benefit of priority to German Patent Application No. 10 2025 100 401.3, filed Jan. 8, 2025, the contents of which is incorporated by reference herein in its entirety.

### FIELD OF THE INVENTION

The invention relates to a rotational antenna system for direction finding and/or position estimation with respect to a signal source wirelessly providing a radio frequency, RF, signal and a method for direction finding and/or position estimation with respect to a signal source wirelessly providing a RF signal.

### BACKGROUND

In times of an increasing number of applications providing navigation capabilities, there is growing need for a rotational antenna system for direction finding and/or position estimation with respect to a signal source wirelessly providing a RF signal and a method for direction finding and/or position estimation with respect to a signal source wirelessly providing a RF signal in order to at least support such applications.

Disadvantageously, common direction finding or position estimation, respectively, requires complex and expensive equipment and is typically quite inaccurate.

For instance, JP 2003050276 A discloses a bistatic Doppler radar system having a two-sided switching antenna, wherein said bistatic Doppler radar system comprises a transmitter station composed of a Doppler radar and a bistatic receiver station provided at a predetermined distance from the transmitter station. The bistatic receiving station has a two-plane switching antenna for observing two arc-shaped dual Doppler analysis ranges on both sides of a baseline defined by the transmitting station and the receiving station with one receiver.

### PROBLEM AND SOLUTION

Accordingly, it is an object of the invention to provide a rotational antenna system for direction finding and/or position estimation with respect to a signal source wirelessly providing a RF signal and a method for direction finding and/or position estimation with respect to a signal source wirelessly providing RF signal, wherein a particularly high cost-efficiency and accuracy can be achieved.

The object is solved with regard to the rotational antenna system for direction finding and/or position estimation with respect to a signal source wirelessly providing a RF signal by the features of the first independent patent claim. The object is solved with respect to the method for direction finding and/or position estimation with respect to a signal source wirelessly providing RF signal by the features of the second independent patent claim. The dependent patent claims contain advantageous further embodiments.

### DETAILED DESCRIPTION OF THE INVENTION

According to a first aspect of the invention, a rotational antenna system for direction finding and/or position estimation with respect to a signal source wirelessly providing a radio frequency, RF, signal is provided. Said rotational antenna system comprises at least two antennas, at least two receiving units respectively being in communication with a corresponding one of the at least two antennas, a rotary positioning unit configured to rotate at least one or at least two or each of the at least two antennas around a rotation point and/or a rotation axis, and a processing unit being in communication with the at least two receiving units. In this context, each of the at least two receiving units is configured to obtain a corresponding one of at least two receive results with respect to the RF signal with the aid of the at least two antennas during rotation. In addition to this, the processing unit is configured to find a corresponding direction and/or to estimate a corresponding position with respect to the signal source based on at least one or at least two or each of the at least two receive results.

Advantageously, a particularly high cost-efficiency and accuracy can be achieved.

According to an implementation form of the first aspect of the invention, the rotary positioning unit is configured to provide positioning information with respect to at least one or at least two or each of the at least two antennas for the processing unit. Furthermore, the processing unit is configured to find the corresponding direction and/or to estimate the corresponding position with respect to the signal source based on said positioning information.

Advantageously, for instance, accuracy can further be increased.

According to an implementation form of the first aspect of the invention, at least one or at least two or each of the receive results comprises or is a corresponding Doppler shift.

Advantageously, for example, complexity can be reduced, thereby increasing cost-efficiency.

According to an implementation form of the first aspect of the invention, especially for finding the corresponding direction and/or estimating the corresponding position with respect to the signal source, the processing unit is configured to compare at least partially the at least two receive results with each other.

Advantageously, for instance, inefficiencies can further be reduced.

According to an implementation form of the first aspect of the invention, especially for finding the corresponding direction and/or estimating the corresponding position with respect to the signal source, the processing unit is configured to determine an angle of arrival with respect to the RF signal based on the positioning information and at least one or at least two or each of the at least two receive results.

Advantageously, for example, inaccuracies can further be reduced.

According to an implementation form of the first aspect of the invention, the rotational antenna system further comprises a fixed and/or not rotatable omnidirectional antenna being in communication with a corresponding one of the at least two receiving units and/or the processing unit. In this context, the processing unit is configured to obtain an additional receive result with respect to the RF signal with the aid of the fixed and/or not rotatable omnidirectional antenna. In addition to this, the processing unit is configured to use said additional receive result for hybrid Doppler and/or time of arrival and/or time-difference of arrival direction finding with respect to the signal source.

Advantageously, for instance, speed of signal localization can be increased.

According to an implementation form of the first aspect of the invention, a corresponding number of the antennas is equal to a corresponding number of the receiving units. In addition to this or as an alternative, the rotational antenna system comprises a receiver having a number of receive channels being equal to the corresponding number of the receiving units, said receiver replacing the receiving units. Further additionally or further alternatively, at least one or at least two or each of the at least two antennas comprises or is a omnidirectional antenna or a directional antenna or a slot antenna, preferably a tapered slot antenna or a Vivaldi antenna.

Advantageously, for example, flexibility can be increased, thereby increasing efficiency.

According to an implementation form of the first aspect of the invention, the rotational antenna system further comprises a rotary joint, especially having multiple channels. In this context, at least one or at least two or each of the at least two antennas is connected to a corresponding one of the at least two receiving units via said rotary joint.

Advantageously, for instance, the receiving units can be fixed or not rotatable, respectively.

According to an implementation form of the first aspect of the invention, the rotational antenna system further comprises a slip ring, especially a hybrid power and data slip ring. In this context, at least one or at least two or each of the at least two antennas and its respectively corresponding one of the at least two receiving units is connected to the processing unit via said slip ring.

Advantageously, for example, the processing unit can be fixed or not rotatable, respectively.

According to an implementation form of the first aspect of the invention, the rotational antenna system further comprises an energy storage, especially a battery. In this context, the energy storage is configured to power at least one or at least two or each of the at least two antennas and its respectively corresponding one of the at least two receiving units. In addition to this, said corresponding ones of the at least two receiving units are in wireless communication with the processing unit.

Advantageously, for instance, the processing unit can be movable or remote, respectively.

According to an implementation form of the first aspect of the invention, especially in the context of obtaining a corresponding one of the at least two receive results with respect to the RF signal, at least one or each of the at least two receiving units is configured to demodulate a corresponding one of the at least two receive results for at least one known signal.

Advantageously, for example, this allows for efficiently demodulating for a mobile communications signal, such as an LTE signal and/or a 5G signal.

According to a second aspect of the invention, a method for direction finding and/or position estimation with respect to a signal source wirelessly providing a radio frequency, RF, signal is provided. Said method comprises the steps of providing at least two antennas, rotating at least one or at least two or each of the at least two antennas around a rotation point and/or a rotation axis, respectively obtaining a corresponding one of at least two receive results with respect to the RF signal with the aid of the at least two antennas during rotation, and finding a corresponding direction and/or estimating a corresponding position with respect to the signal source based on at least one or at least two or each of the at least two receive results.

Advantageously, a particularly high cost-efficiency and accuracy can be achieved.

It is noted that all implementation forms of the first aspect of the invention can apply to the second aspect of the invention in an analogous manner.

### DESCRIPTION OF PREFERRED EMBODIMENTS

A detailed exemplary description of some embodiments of the invention is given below with reference to the figures according to the drawings. In this context:

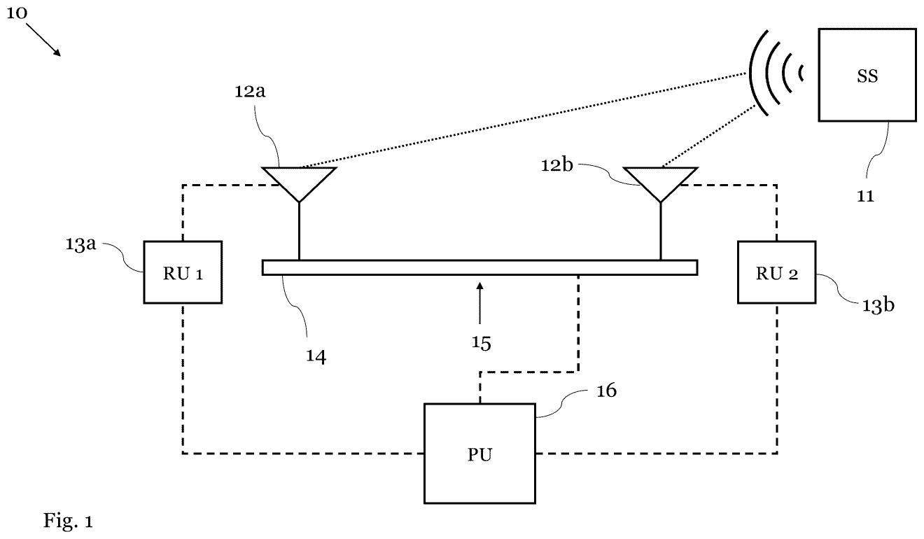

FIG. 1 shows a first exemplary embodiment of a rotational antenna system for direction finding and/or position estimation with respect to a signal source wirelessly providing a RF signal;

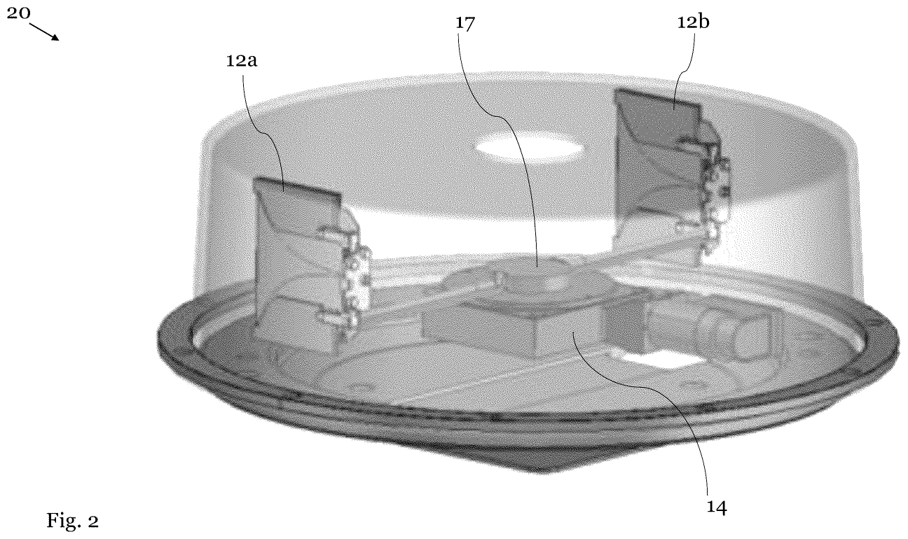

FIG. 2 shows a second exemplary embodiment of a rotational antenna system based on the first exemplary embodiment according to FIG. 1;

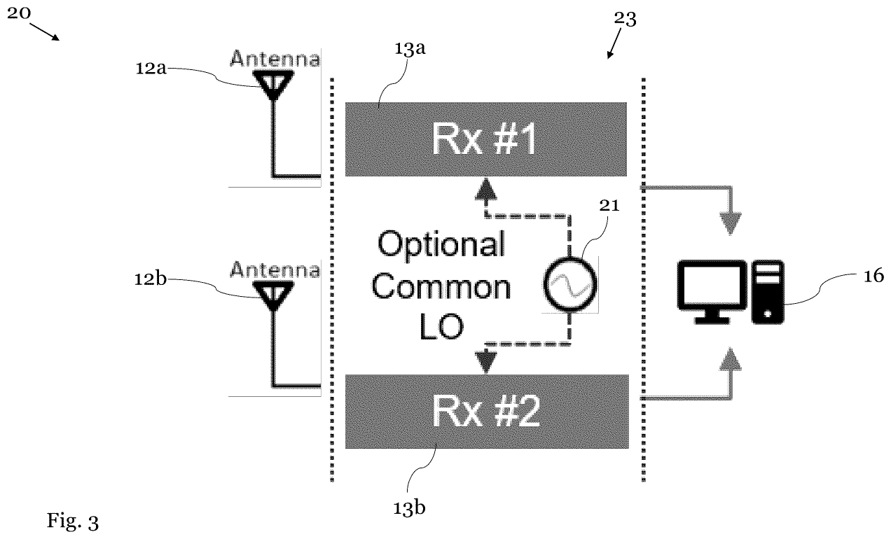

FIG. 3 shows an illustration for further elucidation of the second exemplary embodiment of FIG. 2;

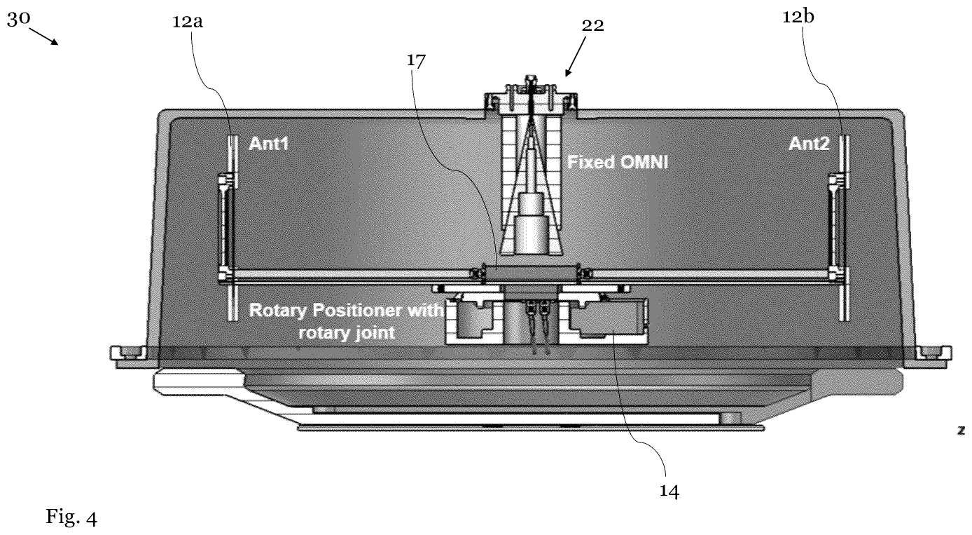

FIG. 4 shows a third exemplary embodiment of a rotational antenna system based on the first exemplary embodiment according to FIG. 1;

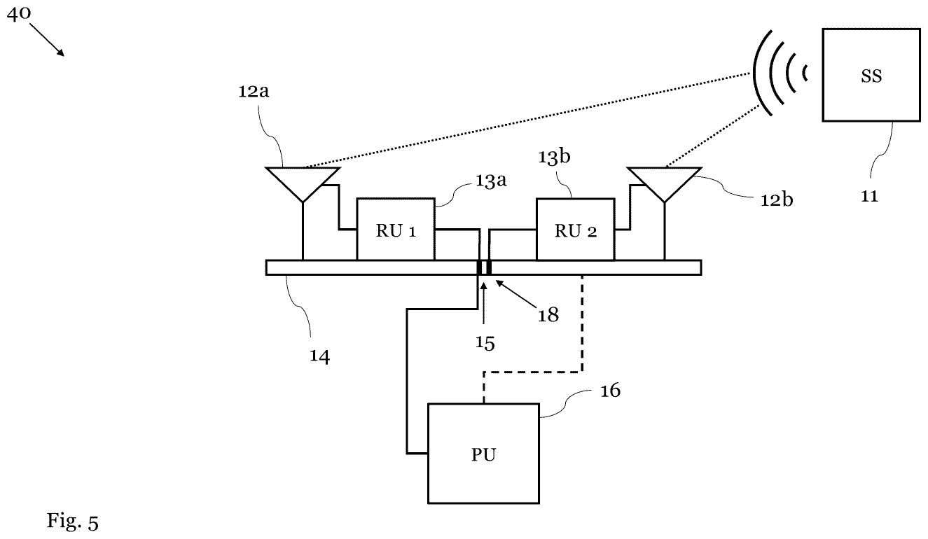

FIG. 5 shows a fourth exemplary embodiment of a rotational antenna system based on the first exemplary embodiment according to FIG. 1;

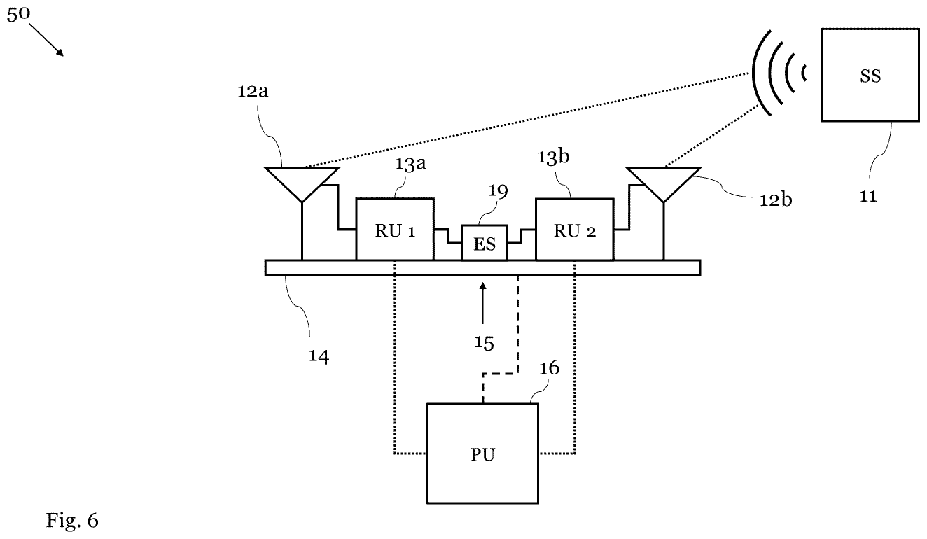

FIG. 6 shows a fifth exemplary embodiment of a rotational antenna system based on the first exemplary embodiment according to FIG. 1; and

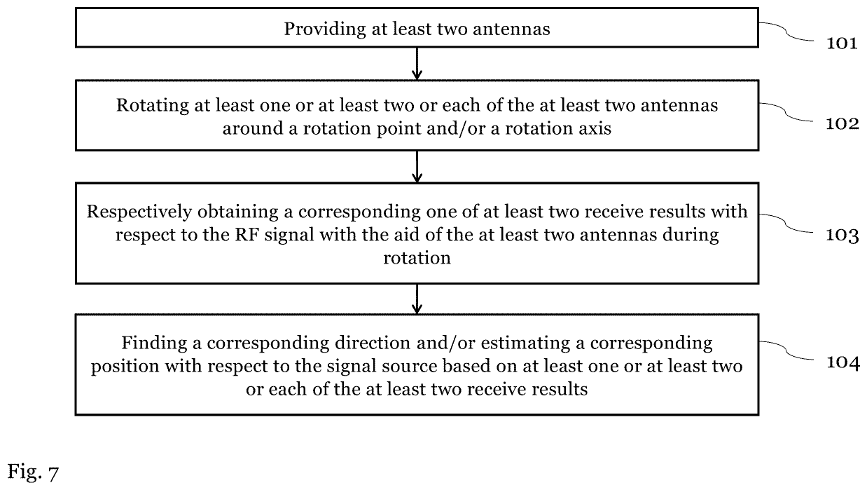

FIG. 7 shows a flow chart of an exemplary embodiment of a method for direction finding and/or position estimation with respect to a signal source wirelessly providing a RF signal.

FIG. 1 illustrates a first exemplary embodiment of a rotational antenna system 10 for direction finding and/or position estimation with respect to a signal source 11 wirelessly providing a radio frequency, RF, signal.

In accordance with said FIG. 1, the rotational antenna system 10 comprises at least two antennas, exemplarily two antennas 12a, 12b, at least two receiving units, exemplarily two receiving units 13a, 13b, respectively being in communication with a corresponding one of the at least two antennas or the two antennas 12a, 12b, respectively.

Generally, the rotational antenna system 10 further comprises a rotary positioning unit configured to rotate at least one or at least two or each of the at least two antennas around a rotation point and/or a rotation axis. In particular, in this exemplary case according to FIG. 1, the rotational antenna system 10 comprises the rotary positioning unit 14 configured to rotate each of the two antennas 12a, 12b around the rotation point and/or the rotation axis 15.

It is noted that it might be particularly advantageous if the two antennas 12a, 12b are connected with the aid of a connection axis, especially wherein the rotation point and/or the rotation axis 15 divides said connection axis symmetrically and/or in half.

As it can further be seen from FIG. 1, the rotational antenna system 10 further comprises a processing unit 16 being in communication with the at least two receiving units or the two receiving units 13a, 13b, respectively.

Generally, each of the at least two receiving units is configured to obtain a corresponding one of at least two receive results with respect to the RF signal with the aid of the at least two antennas during rotation. Additionally, the processing unit is configured to find a corresponding direction and/or to estimate a corresponding position with respect to the signal source based on at least one or at least two or each of the at least two receive results.

Accordingly, in this exemplary case according to FIG. 1, each of the two receiving units 13a, 13b is configured to obtain a corresponding one of two receive results with respect to the RF signal with the aid of the two antennas 12a, 12b during rotation. Additionally, the processing unit 16 is configured to find a corresponding direction and/or to estimate a corresponding position with respect to the signal source 11 based on at least one or each of the two receive results.

It is noted that it might be particularly advantageous if the rotary positioning unit 14 is configured to provide positioning information with respect to at least one or at least two or each of the at least two antennas, exemplarily with respect to at least one or each of the two antennas 12a, 12b, for the processing unit 16. In this context, the processing unit 16 may especially be configured to find the corresponding direction and/or to estimate the corresponding position with respect to the signal source 11 based on said positioning information.

Accordingly, it might be particularly advantageous if the processing unit 16 is configured to find the corresponding direction and/or to estimate the corresponding position with respect to the signal source 11 based on at least one or each of the two receive results and the positioning information, preferably based on each of the two receive results and the positioning information.

With respect to the positioning information, it is noted that it might be particularly advantageous if said positioning information comprises or is respective angle and/or speed with respect to the corresponding antennas.

With respect to the at least two receiving units or the two receiving units 13a, 13b, respectively, it is noted that it might be particularly advantageous if the at least two receiving units or the two receiving units 13a, 13b, respectively, are configured such that the (at least) two receiving units are phase-coherent.

It is further noted that it might be particularly advantageous if at least one or at least two or each of the receive results comprises or is a corresponding Doppler shift. In particular, in this exemplary case, at least one or each of the two receive results may comprise or be a corresponding Doppler shift.

For instance, the Doppler of the signal source 11 can especially be measured for each antenna as a function of angle and/or speed of each rotating antenna or as a function of the positioning information, respectively. Further exemplarily, one of the two antennas 12a, 12b may measure a positive Doppler shift, whereas the other one of the two antennas 12a, 12b may measure a negative Doppler shift.

Moreover, it might be particularly advantageous if, especially for finding the corresponding direction and/or estimating the corresponding position with respect to the signal source 11, the processing unit 16 is configured to compare at least partially the at least two receive results with each other or to compare the two receive results with each other, respectively.

For example, the corresponding comparison can comprise or be a convolution and/or forming a difference and/or a correlation. Further exemplarily, the processing unit 16 can be configured to convolute a first Doppler shift, especially measured by one of the two antennas 12a, 12b and its corresponding receiving unit of the two receiving units 13a, 13b, such as the above-mentioned positive Doppler shift, and a second Doppler shift, especially measured by the other one of the two antennas 12a, 11b and its corresponding receiving unit of the two receiving units 13a, 13b, such as the above-mentioned negative Doppler shift.

Furthermore, it might be particularly advantageous if, especially for finding the corresponding direction and/or estimating the corresponding position with respect to the signal source 11, the processing unit 16 is configured to determine an angle of arrival with respect to the RF signal based on the positioning information and at least one or at least two or each of the at least two receive results or based on the positioning information and at least one or each of the two receive results, respectively.

For instance, based on the above-mentioned comparison, exemplarily the convolution and/or difference and/or correlation, of the above-mentioned Doppler shifts and the positioning information, exemplarily respective angle and/or speed, of the rotating antennas 12a, 12b, the processing unit 16 can determine said angle of arrival with respect to the RF signal.

With respect to the RF signal, it is noted that said RF signal can exemplarily comprise or be at least one of a cellular signal, a periodic signal, a pulsed signal, or any combination thereof. Said RF signal or its signal portions, respectively, can be known and/or unknown. For instance, a known periodic signal can be a mobile communications signal, such as an LTE signal and/or a 5G signal. Further exemplarily, an unknown pulse signal can be a radar signal.

It is further noted that it might be particularly advantageous if a corresponding number of the antennas is equal to a corresponding number of the receiving units. In this exemplary case, said number is two. Exemplarily, the antenna 12a is in communication with the receiving unit 13a, and the antenna 12b is in communication with the receiving unit 13b.

Moreover, it might be particularly advantageous if at least one or at least two or each of the at least two antennas or at least one or each of the two antennas 12a, 12b, respectively, comprises or is an omnidirectional antenna or a directional antenna or a slot antenna, preferably a tapered slot antenna or a Vivaldi antenna.

It is further noted that it might be particularly advantageous if, especially in the context of respectively obtaining a corresponding one of the at least two receive results, exemplarily of the two receive results, with respect to the RF signal, at least one or each of the at least two receiving units, exemplarily at least one or each of the two receiving units 13a, 13b, is configured to demodulate a corresponding one of the at least two receive results or of the two receive results, respectively, for at least one known signal, such as the above-mentioned mobile communications signal.

With respect to the above-mentioned rotary positioning unit 14, it is noted that it might be particularly advantageous if said rotary positioning unit 14 comprises at least one or at least two or each of the at least two antennas, exemplarily at least one or each of the two antennas 12a, 12b.

With respect to the above-mentioned signal source 11, it is noted that it might be particularly advantageous if said signal source 11 comprises or is a base station.

In advance, with respect to the explanations below, it is noted that each of the following exemplary embodiments of the rotational antenna system is based on the one according to FIG. 1 as discussed above. Thus, in the following, parts and elements to be understood as being equal or analogous to the above-mentioned parts and elements are not explicitly explained again but equipped with the same reference signs. Accordingly, in the following, especially the respective differences of the corresponding embodiment with respect to the embodiment of FIG. 1 are explicitly discussed.

Now, with respect to FIG. 2 and FIG. 3, a second exemplary embodiment of a rotational antenna system 20 is illustrated. Said rotational antenna system 20 further comprises a rotary joint 17, especially having multiple channels, wherein at least one or at least two or each of the at least two antennas, exemplarily at least one or each of the two antennas 12a, 12b, is connected to a corresponding one of the at least two receiving units, exemplarily of the two receiving units 13a, 13b, via said rotary joint 17.

It is noted that it might be particularly advantageous if a corresponding number of the multiple channels is equal to a corresponding number of the antennas and/or a corresponding number of the receiving units. In this exemplary case, said number is two. Exemplarily, the antenna 12a is connected to the receiving unit 13a via a first channel of the rotary joint 17, and the antenna 12b is connected to the receiving unit 13b via a second channel of the rotary joint 17.

It is further noted that at least one or at least two or each of the at least two receiving units, exemplarily at least one or each of the two receiving units 13a, 13b, can be arranged in a fixed and/or not rotatable manner. Additionally or alternatively, the processing unit 16 can be arranged in a fixed and/or not rotatable manner.

As indicated by FIG. 3, it might be particularly advantageous if the rotational antenna system 20 comprises a receiver 23 having a number of receive channels being equal to the corresponding number of the receiving units, said receiver 23 replacing the receiving units. Accordingly, said receiver 23 may exemplarily comprise two receive channels.

As further indicated by said FIG. 3, it might be particularly advantageous if the processing unit 16 comprises or is a computer.

As it can further be seen from said FIG. 3, it is noted that it might be particularly advantageous if the rotational antenna system 20 or the receiver 23, respectively, comprises a common local oscillator for the at least two receiving units, exemplarily the two receiving units 13a, 13b, or the at least two receive channels, exemplarily the two receive channels, respectively.

Now, with respect to FIG. 4, a third exemplary embodiment of a rotational antenna system 30 is depicted. In addition to the above-mentioned rotary joint 17, said rotational antenna system 30 further comprises a fixed and/or not rotatable omnidirectional antenna 22 being in communication with a corresponding one of the at least two receiving units, exemplarily a corresponding one of the two receiving units 13a, 13b or a corresponding one of the two receiving units 13a, 13b and an additional receiving unit, and/or the processing unit 16.

In this context, the processing unit 16 is configured to obtain an additional receive result with respect to the RF signal with the aid of the fixed and/or not rotatable omnidirectional antenna 22. In addition to this, the processing unit 16 is configured to use said additional receive result for hybrid Doppler and/or time of arrival and/or time-difference of arrival direction finding with respect to the signal source 11.

It is noted that it might be particularly advantageous if the fixed and/or not rotatable omnidirectional antenna 22 is arranged at or in an area of the above-mentioned rotation point and/or the above-mentioned rotation axis 15.

Furthermore, FIG. 5 illustrates a fourth exemplary embodiment of a rotational antenna system 40. Said rotational antenna system 40 further comprises a slip ring 18, especially a hybrid power and data slip ring, wherein at least one or at least two or each of the at least two antennas, exemplarily each of the two antennas 12a, 12b, and its respectively corresponding one of the at least two receiving units, exemplarily each of the two receiving units 13a, 13b, is connected to the processing unit via said slip ring 18.

It is noted that it might be particularly advantageous if the slip ring 18 is arranged at or in an area of the above-mentioned rotation point and/or the above-mentioned rotation axis 15.

For instance, at least one or at least two or each of the at least two receiving units, exemplarily each of the two receiving units 13a, 13b, can be arranged in a rotatable manner. Additionally or alternatively, the processing unit 16 can be arranged in a fixed and/or not rotatable manner. Further additionally or further alternatively, the rotary positioning unit 14 can comprise the at least two antennas, exemplarily the two antennas 12a, 12b, and the at least two receiving units, exemplarily the two receiving units 13a, 13b.

Further exemplarily, with the aid of the slip ring 18, not only the receive results can be provided for the processing unit 16, but also the rotatable antennas 12a, 12b and/or the rotatable receiving units 13a, 13b can be supplied with power.

Moreover, FIG. 6 depicts a fifth exemplary embodiment of a rotational antenna system 50. Said rotational antenna system 50 further comprises an energy storage 19, especially a battery, wherein the energy storage is configured to power at least one or at least two or each of the at least two antennas, exemplarily each of the two antennas 12a, 12b, and its respectively corresponding one of the at least two receiving units, exemplarily each of the two receiving units 13a, 13b. In addition to this, said corresponding ones of the at least two receiving units, exemplarily the two receiving units 13a, 13b, are in wireless communication with the processing unit 16.

It is noted that the processing unit 16 can be arranged in a movable and/or not rotatable manner. In addition to this or as an alternative, the processing unit 16 can be arranged in a remote manner, especially with respect to the rotary positioning unit 14. Further additionally or further alternatively, the rotary positioning unit 14 can comprise the at least two antennas, exemplarily the two antennas 12a, 12b, and the at least two receiving units, exemplarily the two receiving units 13a, 13b.

Finally, FIG. 7 illustrates a flow chart of an exemplary embodiment of a method for direction finding and/or position estimation with respect to a signal source, such as the above-mentioned signal source 11, wirelessly providing a RF signal.

It is noted that said method may especially use one of the above-mentioned rotational antenna systems 10, 20, 30, 40, 50.

As it can be seen from FIG. 7, a first step 101 comprises providing at least two antennas, such as the above-mentioned antennas 12a, 12b. A second step 102 comprises rotating at least one or at least two or each of the at least two antennas around a rotation point and/or a rotation axis, especially with the aid of the above-mentioned rotary positioning unit 14. A third step 103 comprises respectively obtaining a corresponding one of at least two receive results with respect to the RF signal with the aid of the at least two antennas during rotation, especially by using the above-mentioned receiving units 13a, 13b. A fourth step 104 comprises finding a corresponding direction and/or estimating a corresponding position with respect to the signal source based on at least one or at least two or each of the at least two receive results, especially with the aid of the above-mentioned processing unit 16.

The invention is not limited to the embodiments discussed above. All features described in the description or claimed in the patent claims or drawn in the drawing can be combined with each other as desired within the scope of the present invention.

1. A rotational antenna system for direction finding and/or position estimation with respect to a signal source wirelessly providing a radio frequency, RF, signal, the rotational antenna system comprising:
at least two antennas,
at least two receiving units respectively being in communication with a corresponding one of the at least two antennas,
a rotary positioning unit configured to rotate at least one or at least two or each of the at least two antennas around a rotation point and/or a rotation axis, and
a processing unit being in communication with the at least two receiving units,
wherein each of the at least two receiving units is configured to obtain a corresponding one of at least two receive results with respect to the RF signal with the aid of the at least two antennas during rotation, and
wherein the processing unit is configured to find a corresponding direction and/or to estimate a corresponding position with respect to the signal source based on at least one or at least two or each of the at least two receive results.

2. The rotational antenna system according to claim 1,
wherein the rotary positioning unit is configured to provide positioning information with respect to at least one or at least two or each of the at least two antennas for the processing unit, and
wherein the processing unit is configured to find the corresponding direction and/or to estimate the corresponding position with respect to the signal source (11) based on said positioning information.

3. The rotational antenna system according to claim 1,
wherein at least one or at least two or each of the receive results comprises or is a corresponding Doppler shift.

4. The rotational antenna system according to claim 1,
wherein, especially for finding the corresponding direction and/or estimating the corresponding position with respect to the signal source, the processing unit is configured to compare at least partially the at least two receive results with each other.

5. The rotational antenna system according to claim 2,
wherein, especially for finding the corresponding direction and/or estimating the corresponding position with respect to the signal source, the processing unit is configured to determine an angle of arrival with respect to the RF signal based on the positioning information and at least one or at least two or each of the at least two receive results.

6. The rotational antenna system according claim 1, further comprising:
a fixed and/or not rotatable omnidirectional antenna being in communication with a corresponding one of the at least two receiving units and/or the processing unit,
wherein the processing unit is configured to obtain an additional receive result with respect to the RF signal with the aid of the fixed and/or not rotatable omnidirectional antenna, and
wherein the processing unit is configured to use said additional receive result for hybrid Doppler and/or time of arrival and/or time-difference of arrival direction finding with respect to the signal source.

7. The rotational antenna system according to claim 1,
wherein a corresponding number of the antennas is equal to a corresponding number of the receiving units, and/or wherein the rotational antenna system comprises a receiver having a number of receive channels being equal to the corresponding number of the receiving units, said receiver replacing the receiving units, and/or
wherein at least one or at least two or each of the at least two antennas comprises or is an omnidirectional antenna or a directional antenna or a slot antenna, preferably a tapered slot antenna or a Vivaldi antenna.

8. The rotational antenna system according to claim 1, further comprising:
a rotary joint, especially having multiple channels, wherein at least one or at least two or each of the at least two antennas is connected to a corresponding one of the at least two receiving units via said rotary joint.

9. The rotational antenna system according to claim 1, further comprising:
a slip ring, especially a hybrid power and data slip ring, wherein at least one or at least two or each of the at least two antennas and its respectively corresponding one of the at least two receiving units is connected to the processing unit via said slip ring.

10. The rotational antenna system according to claim 1, further comprising:
an energy storage, especially a battery,
wherein the energy storage is configured to power at least one or at least two or each of the at least two antennas and its respectively corresponding one of the at least two receiving units, and
wherein said corresponding ones of the at least two receiving units are in wireless communication with the processing unit.

11. The rotational antenna system according to claim 1,
wherein, especially in the context of obtaining a corresponding one of the at least two receive results with respect to the RF signal, at least one or each of the at least two receiving units is configured to demodulate a corresponding one of the at least two receive results for at least one known signal.

12. A method for direction finding and/or position estimation with respect to a signal source wirelessly providing a radio frequency, RF, signal, the method comprising the steps of:
providing at least two antennas,
rotating at least one or at least two or each of the at least two antennas around a rotation point and/or a rotation axis,
respectively obtaining a corresponding one of at least two receive results with respect to the RF signal with the aid of the at least two antennas during rotation, and
finding a corresponding direction and/or estimating a corresponding position with respect to the signal source based on at least one or at least two or each of the at least two receive results.
